(19) United States
(12) Patent Application Publication
(10) Pub. No.: US 2007/0092685 A1
(43) Pub. Date: Apr. 26, 2007

(54) Skeleton structural member for transportation equipment and manufacturing method for the skeleton structural member

(75) Inventor: Shouzi Yamazaki, Wako-shi (JP)

Correspondence Address: RANKIN, HILL, PORTER & CLARK LLP, 4080 ERIE STREET, WILLOUGHBY, OH, 44094-7836, US

(73) Assignee: Honda Motor Co., Ltd., Tokyo (JP)

(21) Appl. No.: 10/562,590

(22) PCT Filed: Jun. 23, 2004
(86) PCT No.: PCT/JP04/09234

§ 371 Date: Dec. 28, 2005

(30) Foreign Application Priority Data
Jul. 1, 2003 (JP) 2003-189824

(51) Int. Cl. B32B 3/02

(52) U.S. Cl. 428/68

(57) ABSTRACT

A skeleton structural Member having multiple granules (18) packed inside a hollow skeleton member. Partition wall forming members are disposed apart from each other inside a skeleton member, and a closed space is formed by the partition wall forming members and the skeleton member. The closed space is filled with the multiple granules. By the partition wall forming members being heated to make them expand, partition members are formed, and the internal pressure of the closed space increases.

### TECHNICAL FIELD

This invention relates to a skeleton structure member for use in a transport machine such as a railroad car, an industrial vehicle, a ship, an aircraft, an automobile or a motorcycle, and to a manufacturing method of the same skeleton structural member.

### BACKGROUND ART

Skeleton structure members made by filling a skeleton member with a granular bulk material are known from for example JP-A-2002-193649, U.S. Pat. No. 4,610,836 and U.S. Pat. No. 4,695,343.

FIG. 10 shows a solidified granular bulk material of a skeleton structure member disclosed in JP-A-2002-193649.

This solidified granular bulk material 200 is made up of multiple granules 201 and a binder 202 consisting of a resin or an adhesive filled between these granules 201 to make the granules 201 into a solid, and is solidified by the multiple granules being bonded together. The solidified granular bulk material 200 is formed by the granules 201 being packed densely in a mold and the binder 202 being poured in after that. This solidified granular bulk material 200 is inserted into a skeleton member of a vehicle body or the like to make a skeleton structure member, and the strength and rigidity of the vehicle body is thereby raised.

FIG. 11 shows a solidified granular bulk material of a skeleton structure member set forth in U.S. Pat. No. 4,610,836 and U.S. Pat. No. 4,695,343.

This solidified granular bulk material 210 is made up of multiple small glass spheres 212 serving as granules coated with an adhesive 211. These glass spheres 212 are wrapped with a cloth made of glass fiber and packed into a skeleton member to make a skeleton structure member.

However, in the solidified granular bulk material 200 shown in FIG. 10, compared to the case of the granules 201 only, the weight is greater by an amount corresponding to the binder 202. And similarly in the case of the solidified granular bulk material 210, compared to the case of the small spheres 212 only, the weight is greater by an amount corresponding to the adhesive 211. Consequently, the weight of skeleton structure members in which these solidified granular bulk materials 200, 210 are used becomes large.

And, although if the granules 201 or the small spheres 212 are packed densely the rigidity of the solidified granular bulk material 200, 210 is raised, to pack the granules 201 or the small spheres 212 into a closed space it is necessary to devise means for applying pressure to them from outside, and it is not easy.

Next, the absorbed energies of skeleton structure members in which the above-mentioned solidified granular bulk materials 200, 210 have been used will be obtained by forcibly bending the skeleton structure members in a bending test.

FIG. 12 shows a method of a skeleton structure member bending test. The bending test is carried out by supporting a skeleton structure member 220 on two support points 221, 221 and applying a downward load F to the upper face of the skeleton structure member 220 at a central position between the support points 221, 221 via a pushing piece 222 of the bending test apparatus. The symbol 6 is the stroke, i.e. the downward displacement, of the pushing piece 222. The reference number 223 denotes a solidified granular bulk material inserted into the skeleton structure member 220.

FIG. 13 is a graph showing a relationship between load and displacement obtained as the result of a bending test on a skeleton structure member. The vertical axis shows the load F and the horizontal axis the displacement δ.

In this graph, while the displacement δ is small, the load F rises sharply in a straight line, and a maximum load f1 is reached. After that, as the displacement δ increases, the load F gradually decreases, and eventually becomes roughly constant.

If the load at the upper end of the straight part of the rise is written L and the angle of the straight line is written α, then the greater is the angle α and the greater is the load L (i.e. the longer is the straight line), the greater is the rigidity of the skeleton structure member. Also, the greater is the load f1 the stronger is the skeleton structure member.

The area of the part enclosed by the line of this graph and the horizontal axis is the work done, i.e. the energy absorbed by the deformation of the skeleton structure member, and for example is used to obtain the energy absorbed by the skeleton structure of a vehicle during a crash.

FIG. 14A through FIG. 14D are graphs showing relationships between load F and displacement δ , and absorbed energies, obtained as the results of bending tests on skeleton structure members.

Sample 1 in the graph shown in FIG. 14A is the same member as the skeleton structure member shown in FIG. 13, and is a skeleton structure member having for example a hollow square cross-section and not having a solidified granular bulk material inserted into it.

With Sample 2, the load F is greater than in the case of Sample 1 at displacements greater than the displacement of Sample 1 corresponding to the maximum load f1.

With Sample 3, the load F is greater than in the case of Sample 2 at displacements greater than the displacement of Sample 1 corresponding to the maximum load f1.

The absorbed energies of Samples 1 to Sample 3 are shown in FIG. 14B.

In FIG. 14B, the vertical axis shows absorbed energy E. If the absorbed energies of Sample 1 to Sample 3 are written e1 to e3, then e1<e2<e3.

In FIG. 14C, Sample 4 is a member having a greater angle α of rise (see FIG. 13) than Sample 1 and having a load f2 greater than the load f1 of Sample 1 as its maximum value, and at displacements δ greater than the displacement at the load f2 it gradually comes to overlie Sample 1.

Sample 5 is a member having a greater angle α of rise (see FIG. 13) than Sample 4 and having a load f3 greater than the load f2 of Sample 4 as its maximum value, and at displacements δ greater than the displacement at the load f3 it gradually comes to overlie Sample 1.

The absorbed energies of Sample 1, Sample 4 and Sample 5 are shown in FIG. 14D.

In FIG. 14D, the vertical axis shows the absorbed energy E. If the absorbed energies of Sample 4 and Sample 5 are written e4 and e5, then e1<e4<e5.

From FIG. 14A to FIG. 14D it can be seen that, although the increase in absorbed energy resulting from just the maximum value of the load F increasing is small, if the maximum value of the load F is increased and also the load after the maximum load occurs is kept high, the increase in absorbed energy can be made large.

FIG. 15 shows a state of deformation of a skeleton structure member of related art in a bending test.

For example when a skeleton structure member 205 with a solidified granular bulk material 200 (see also FIG. 10) inserted into it is deformed in a bending test, the part where the solidified granular bulk material 200 was inserted hardly deforms at all, and the parts beyond the ends of the solidified granular bulk material 200 deform greatly. The reference number 206 denotes a bent part of a skeleton member 207 greatly deformed and bent.

This appears to be a result of the strength of the part where the solidified granular bulk material 200 is inserted being very high, because of strong bonding of highly packed granules and a binder, and strain concentrating at parts where the solidified granular bulk material 200 is not present.

FIG. 16 is a graph of bending tests on skeleton members shown as Comparison Examples 1 to 3, in which the vertical axis shows the load F and the horizontal axis the displacement δ . The maximum displacement δ in the data of each case is the value immediately before the load F falls sharply as the displacement δ gradually increases.

Comparison Example 1, shown with a dashed line, is a skeleton structure member having a hollow square cross-section and no solidified granular bulk material inserted, and although the maximum displacement d5 is large, the maximum load f5 is small.

Comparison Example 2, shown with a singly dotted line, is the skeleton structure member shown in FIG. 10 and FIG. 15, that is, having a solidified granular bulk material made by bonding solid granules with a binder, and although since the bonding of the granules is strong the maximum load f6 is large, as a result of the parts where the solidified granular bulk material is not present undergoing great local deformation in the early stage of the bending test, the maximum displacement d6 is small.

Comparison Example 3, shown with a doubly dotted line, is the skeleton structure member shown in FIG. 11, that is, having a solidified granular bulk material made by coating and bonding solid granules with an adhesive, and although since the bonding of the granules is strong the maximum load f7 is larger than in Comparison Example 2, because local deformation is large as in the case of Comparison Example 2, the maximum displacement d7 is small.

FIG. 17 shows the absorbed energies of the skeleton structure members shown in FIG. 16 (Comparison Example 1 to Comparison Example 3). The vertical axis shows absorbed energy E.

When the absorbed energy of Comparison Example 1 is taken as 1.0, the absorbed energy of Comparison Example 2 is lower than that of Comparison Example 1, and that of Comparison Example 3 takes a value approximately the same as Comparison Example 1.

Thus, in Comparison Example 2 and Comparison Example 3, because the granules are bonded strongly the strength of the part of the skeleton structure member packed with the granules becomes excessively high and in the early stage of the bending test local breaking occurs and the load sharply falls, and consequently the absorbed energy is no more than in Comparison Example 1.

Accordingly, a skeleton structure member for use in a transport machine and a method for manufacturing this skeleton structure member have been awaited with which it is possible to suppress weight increase accompanying solidification of the granular bulk material and to pack the granular bulk material into the skeleton member easily, and furthermore with which the absorbed energy of the skeleton structure member is increased.

### DISCLOSURE OF THE INVENTION

The invention provides a skeleton structure member to be used in a transport machine, having a skeleton member, multiple granules packed into the skeleton member and a space bounded by the skeleton member and a panel member peripheral thereto, and a partition wall member formed by expanding at least one partition wall forming member provided in the skeleton member and/or the space to form a closed space to be filled with the multiple granules.

Because a partition wall is formed by expanding a partition wall forming member like this, a closed space can be formed easily and the closed space can be filled with granules simply, without a pressure being applied from outside. Therefore, an internal pressure can be created in the closed space, and by means of this internal pressure for example deformation of a vertical wall part of the skeleton structural member can be suppressed and the rigidity and strength of the skeleton structural member can be increased. As a result, it is possible to support a large load up to a large displacement, and compared to a skeleton structural member of related art it is possible to increase the absorbed energy of the skeleton structural member.

The partition wall forming member, preferably, is expanded more quickly than the rate at which the multiple granules expand. If the expansion of the granules is completed after the partition wall forming member expands and the partition wall member is formed, an internal pressure can be created in the closed space more certainly by means of the granules.

It is desirable for the partition wall forming member to be made of a material that expands easily, such as for example a foaming resin material, because then the weight of the partition wall member is low and the skeleton structural member can be made light.

Also, the invention provides a manufacturing method of a skeleton structural member to be used in a transport machine made by filling a skeleton member and a space bounded by the skeleton member and a panel member peripheral thereto with multiple granules, comprising the steps of disposing a plurality of partition wall forming members for forming partition wall members in the skeleton member and/or the space apart from each other inside a vessel or a bag, placing the granules between the plurality of partition wall forming members, disposing the vessel and its contents or the bag and its contents in the skeleton member and/or the space, and heating the vessel and its contents or the bag and its contents.

If the partition wall forming members and the granules are put into a vessel or a bag, the work of disposing the partition wall forming members and the granules in the skeleton member and/or the space becomes easy, and it is possible to raise the manufacturability of the skeleton structural member.

### BRIEF DESCRIPTION OF THE DRAWINGS

FIG. 1 is a perspective view of a skeleton structural member for use in a transport machine according to the invention;

FIG. 2 is a sectional view of a skeleton structural member according to a first embodiment on the line 2-2 in FIG. 1;

FIG. 3 is a sectional view of a skeleton structural member according to the first embodiment on the line 3-3 in FIG. 1;

FIG. 4A to FIG. 4D are views showing a manufacturing method of a skeleton structural member according to the first embodiment;

FIG. 5A to FIG. 5C are views showing a manufacturing method of a skeleton structural member according to a second embodiment;

FIG. 6A to FIG. 6C are views showing deformation in a bending test of a skeleton structural member according to the invention;

FIG. 7 is a graph showing bending tests on a skeleton structural member according to the invention;

FIG. 8A to FIG. 8C are views showing a manufacturing method of a skeleton structural member according to a third embodiment;

FIG. 9A and FIG. 9B are views showing a manufacturing method of a skeleton structural member according to a fourth embodiment;

FIG. 10 is a sectional view of a first solidified granular bulk material of a skeleton structural member of related art;

FIG. 11 is a sectional view of a second solidified granular bulk material of a skeleton structural member of related art;

FIG. 12 is a view showing a method of a skeleton structural member bending test;

FIG. 13 is a graph showing a relationship between load and displacement in a skeleton structural member bending test;

FIG. 14A to FIG. 14D are graphs showing relationships between load and displacement, and absorbed energy, in bending tests on skeleton structural members;

FIG. 15 is a view showing deformation of a skeleton structural member of related art in a bending test;

FIG. 16 is a graph showing relationships between load and displacement in bending tests on skeleton structural members of Comparison Examples 1 to 3; and

FIG. 17 is a graph showing absorbed energies in the bending tests on skeleton structural members shown in FIG. 16.

### BEST MODES FOR CARRYING OUT THE INVENTION

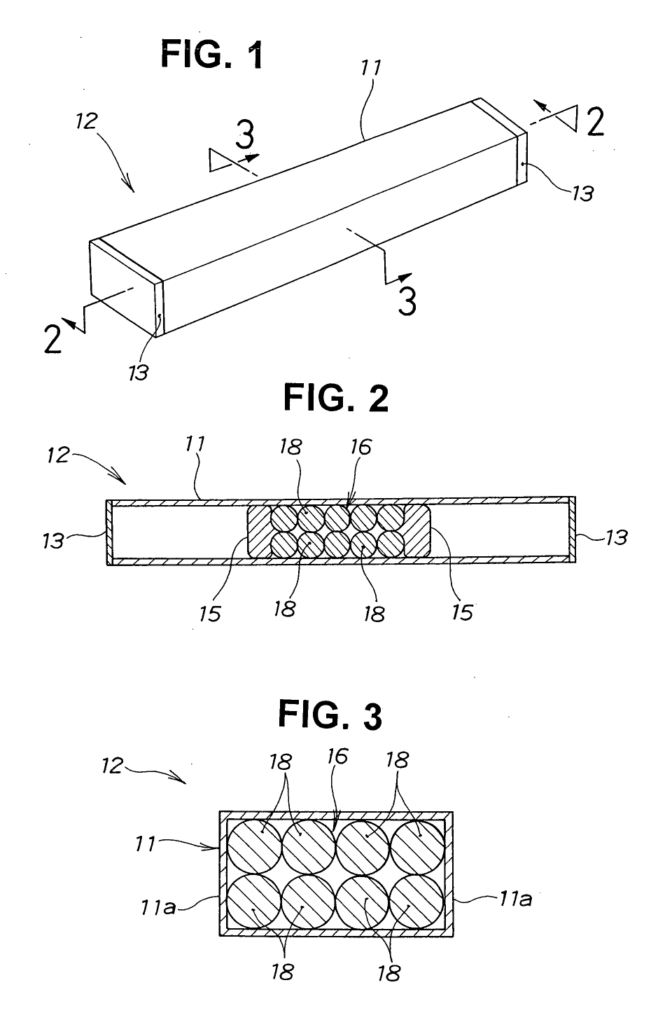

FIG. 1 shows a skeleton structural member 12 for use in a transport machine (hereinafter written simply the skeleton structural member 12′) made by filling the inside of a hollow skeleton member 11 with a solidified granular bulk material. The reference numbers 13, 13 denote end closing members for closing the ends of the skeleton member 11.

The skeleton structural member 12 shown in FIG. 2 is made up of the skeleton member 11; two partition wall members 15, 15 provided apart from each other inside the skeleton member 11; and multiple granules 18 made of a thermoplastic resin, packed in a closed space 16 between these partition wall members 15, 15. Here, the granules 18 are disposed centrally in the length direction of the skeleton structural member 12. The actual diameter of the granules 18 is 10 μm to 5.0 mm.

The partition wall members 15 consist of a foamed resin and are made by foaming a foaming resin material which will be further discussed later. The foaming resin material is a material having a property of foaming at room temperature or when heat is applied to it.

FIG. 3 shows multiple granules 18 packed inside a skeleton member 11 having a hollow square cross-section.

If the partition wall members 15, 15 (see FIG. 2) are formed with a foaming resin as mentioned above, when the foaming resin material expands to form the partition wall members 15, 15, because the foaming resin material pushes on the granules 18 as it expands, after the partition wall members 15 are completed, the closed space 16 has an internal pressure. Because the granules 18 push on the skeleton member 11 like this, the vertical wall parts 11a, 11a of the skeleton member 11 are not readily deformed by forces from outside. For example, when a load acts in the vertical direction on the skeleton structural member 12, compared to a case where nothing is packed inside the skeleton member 11 and the load is supported by the skeleton member 11 only, in this embodiment it is possible to support a larger load.

Although in this embodiment a square member having a closed space in cross-section was shown as the skeleton member, as shown in FIG. 3, in this invention there is no limitation to this, and for example the closed space may be formed by a skeleton member having a sectionally U-shaped open part and a panel member peripheral to the skeleton member that closes the open part. That is, in this invention, multiple granules are packed into a skeleton member and/or a space bounded by a skeleton member and a panel member peripheral to it.

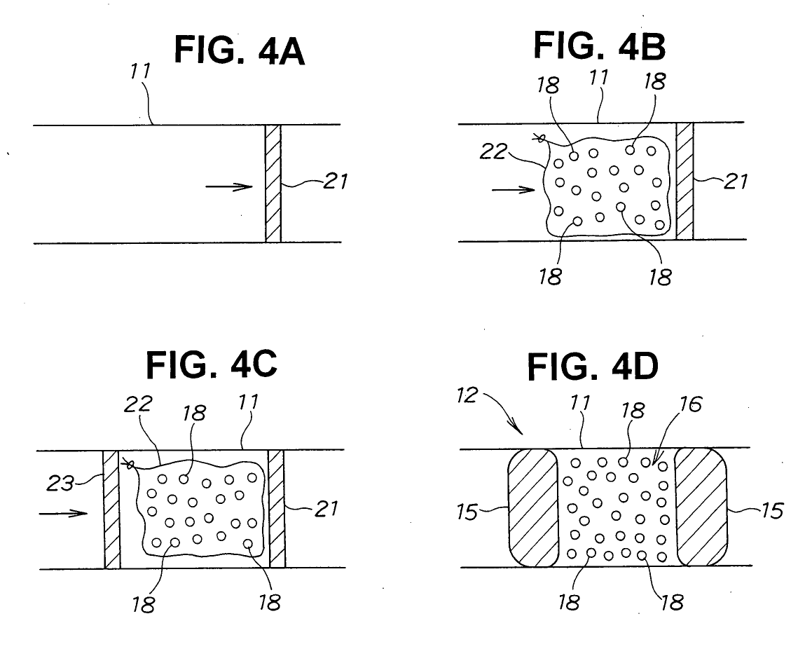

FIG. 4A to FIG. 4D show a manufacturing method of a skeleton structural member according to a first embodiment of the invention.

In FIG. 4A, one partition wall forming member 21 made of a foaming resin material is disposed inside a skeleton member 11. The fit of the inner faces of the skeleton member 11 and the partition wall forming member 21 at this time may be a clearance fit or an interference fit.

In FIG. 4B, a bag 22 packed with granules 18 is placed inside the skeleton member 11.

In FIG. 4C, another partition wall forming member 23 made of a foaming resin material is disposed inside the skeleton member 11, and the granules 18 are sandwiched with the partition wall forming members 21, 23.

The granules 18 and the partition wall forming members 21, 23 are then heated along with the skeleton member 11.

As a result, as shown in FIG. 4D, the partition wall forming members 21, 23 (see FIG. 4C) foam and expand, and become partition wall members 15, 15. And along with the walls of the skeleton member 11, they form a closed space 16. The granules 18 fill the closed space 16. At this time, the bag 22 either melts or disappears under the heating.

After that, the skeleton member 11 is cooled. This completes a skeleton structural member 12.

By putting the granules 18 in a bag 22 and then placing the bag 22 inside the skeleton member 11 like this, the work of placing the granules 18 can be carried out more easily than when they are placed inside the skeleton member 11 directly, and ease of work and the handlability of the granules 18 improve.

And, in FIG. 4C and FIG. 4D, instead of the granules 18, alternatively for example so-called ‘microcapsules’, granules made by atomizing a core substance (liquid or solid) and coating this core substance with a film (that is, wrapping it with a shell), may be placed inside the skeleton member 11. When these microcapsules are heated, the core substance gasifies and the film (that is, the shell) softens and expands, and they become hollow granules.

As the composition of this film (shell), a thermoplastic resin is suitable, that is, (1) acrylic acid, methacrylic acid, itaconic acid, citraconic acid, maleic acid, fumaric acid, vinyl benzoic acid, and esters of these acids, (2) nitriles such as acrylonitrile and methacrylonitrile, (3) vinyl compounds such as vinyl chloride and vinyl acetate, (4) vinylidine compounds such as vinylidine chloride, (5) vinyl aromatics such as styrene, (6) others such as ethylene glycol di (meth)acrylate, di ethylene glycol di (meth)acrylate, tri ethylene glycol (meth)acrylate, neopentyl glycol (meth)acrylate, 1, 6 hexane diol di acrylate, 1, 9 nonane diol di (meth)acrylate, average molecular weight 200 to 600 polyethylene glycol di acrylate, average molecular weight 200 to 600 polyethylene glycol di methacrylate, tri methyl propane di (meth)acrylate, tri methyl propane tri (meth)acrylate, pentaerythritol tetra acrylate, di pentaerythritol acrylate, di pentaerythritol hexa acrylate, and polymers of these monomers and copolymers of combinations of them.

And, as the core substance, low-boiling-point hydrocarbons such as ethane, propane, butane, isobutane, pentane, isopentane, hexane, isohexane, octane, isohexane, and chlorofluorocarbons are suitable.

Also, when the microcapsules mentioned above and the partition wall forming members 21, 23 are disposed inside the skeleton member 11, the partition wall forming members 21, 23 are made to expand more quickly than the microcapsules expand. By this means, when the partition wall forming members 21, 23 have expanded to make the partition wall members 15, 15, when the expansion of the microcapsules finishes, an internal pressure in the closed space 16 can be created more certainly.

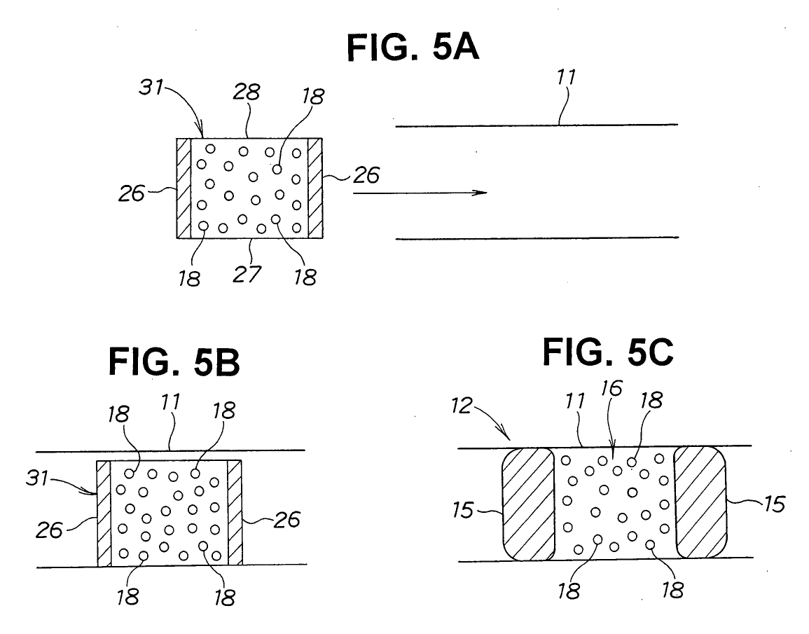

FIG. 5A to FIG. 5C show a manufacturing method of a skeleton structural member according to a second embodiment of the invention.

In FIG. 5A, multiple granules 18 are put in a vessel 31 made up of partition wall forming members 26, 26, a lower plate 27 and a cover 28, and inserted into the skeleton member 11 along with the vessel 31.

In FIG. 5B, the skeleton member 11 and the vessel 31 are heated.

In FIG. 5C, the partition wall forming members 26, 26 shown in FIG. 5B are foamed and expanded and become partition wall members 15, 15, and form a closed space 16 along with the walls of the skeleton member 11. The granules 18 fill the inside of the closed space 16. At this time, the lower plate 27 and the cover 28 of the vessel 31 melt or disappear under the heating.

After that, the skeleton member 11 is cooled. This completes the skeleton structural member 12.

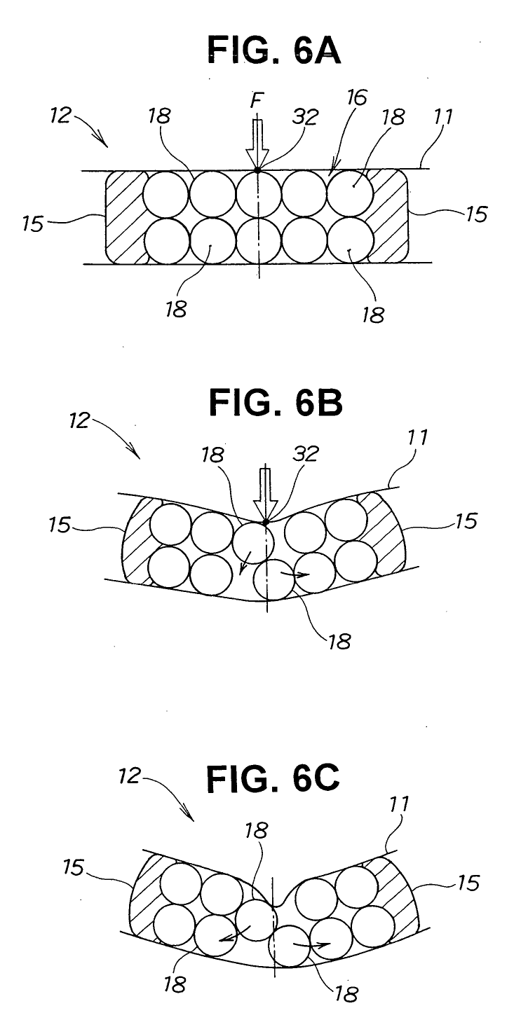

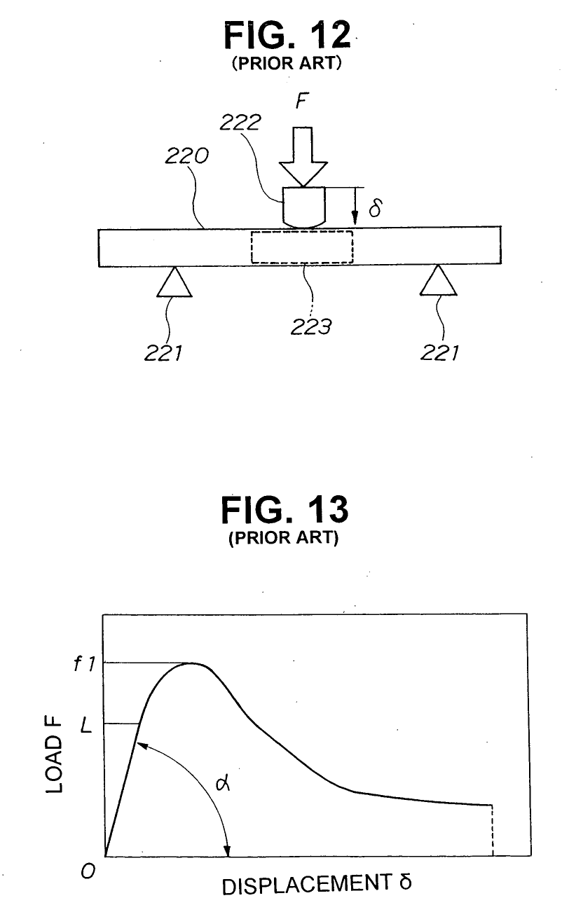

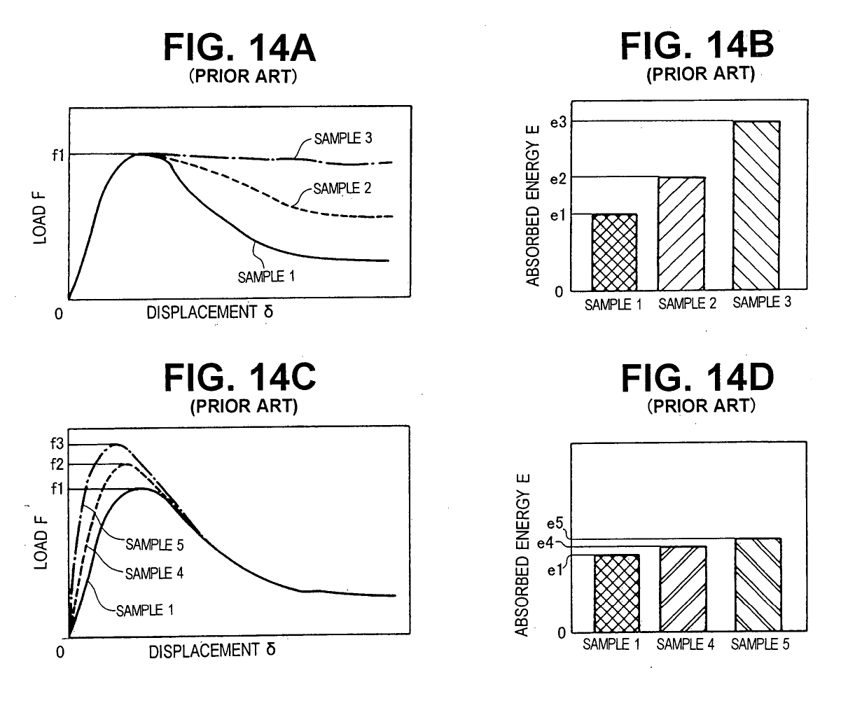

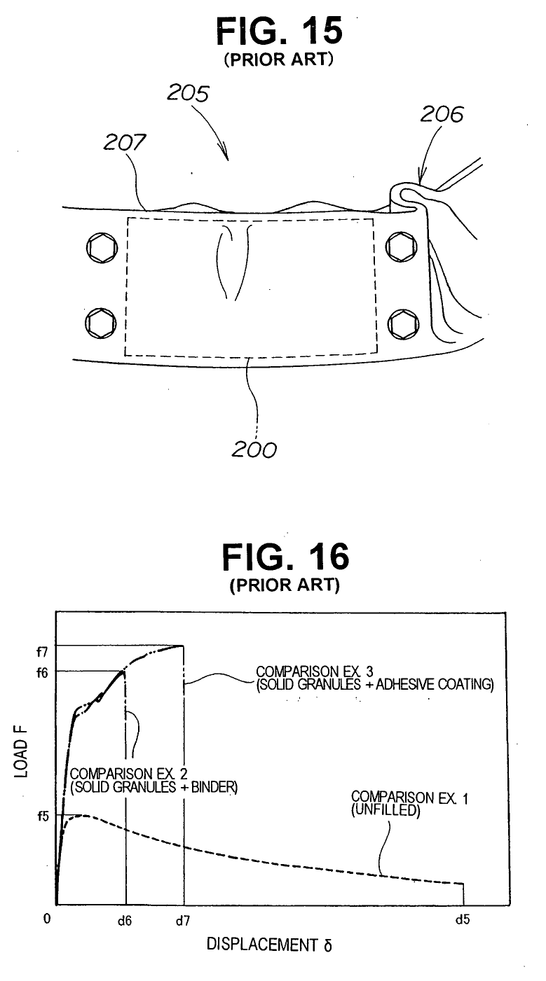

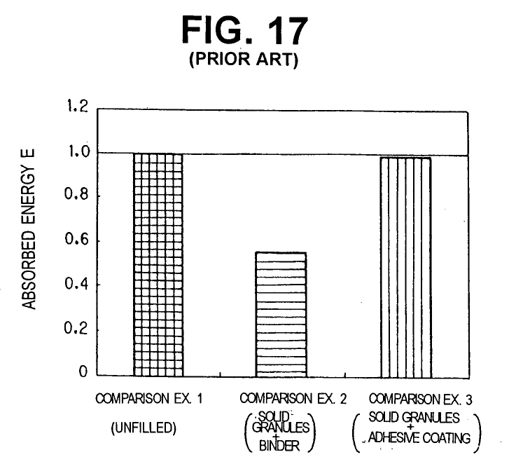

FIG. 6A to FIG. 6C show deformation of a skeleton structural member according to the invention in a bending test. By the same method as that shown in FIG. 12, a bending test was carried out on the skeleton structural member 12, and the deformation of the skeleton structural member 12 at that time, and more specifically the deformation of the closed space 16, will now be discussed.

In FIG. 6A, a load F is applied to the skeleton structural member 12. The reference number 32 denotes a load application point on the skeleton member 11 at which the load F is applied.

In FIG. 6B, the skeleton structural member 12 bends, and at the granules 18 in the vicinity of the load application point 32 the granules 18 move in the direction of the partition wall members 15, 15 as shown with arrows and suppress sharp increasing of the internal pressure of the skeleton member 11.

In FIG. 6C, when the bending of the skeleton structural member 12 increases further, the granules 18 flow further toward the partition wall members 15, 15 as shown with arrows and distribute the strain.

Accordingly, because the skeleton structural member 12 does not deform locally, and deforms substantially uniformly, by means of this flow it can deform stably up to a large displacement while maintaining a large load.

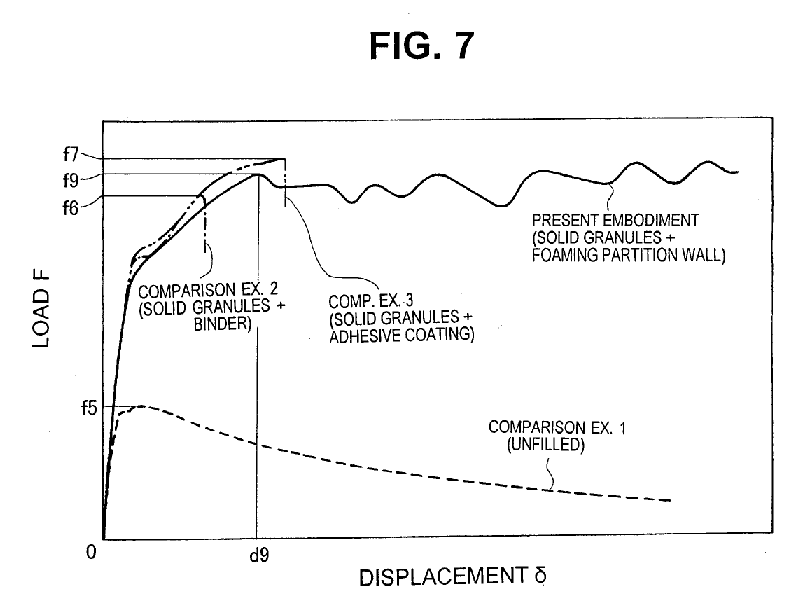

FIG. 7 is a graph showing a bending test on a skeleton structural member according to the invention, in which the vertical axis shows load F and the horizontal axis displacement δ.

In the data of the skeleton structure member 12 (shown with a solid line) of the embodiment (solid granules+foamed partition walls), the rise angle, the length of the straight line part of that rise, and the maximum load f9 at the displacement d9 are substantially the same as in Comparison Example 2 and Comparison Example 3 discussed earlier, and in the rigidity and strength points there is no great difference. Also, a large load F is maintained up to a large displacement σ, that is, a load close to a load f9 is maintained. Thus, with the skeleton structure member 12 of this invention, it is possible to increase the absorbed energy compared to Comparison Example 1 through Comparison Example 3.

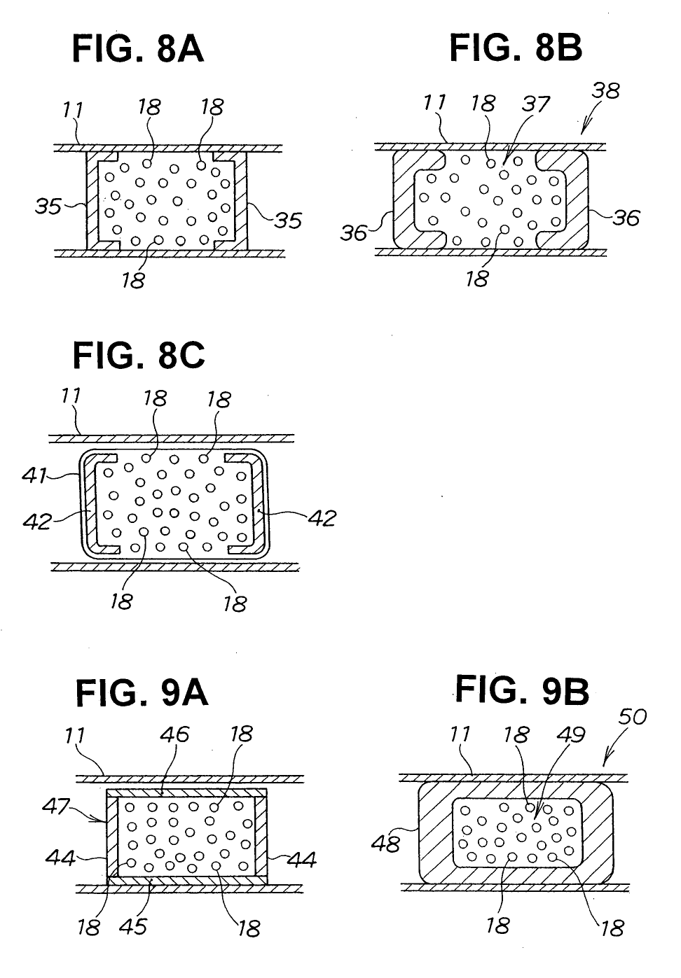

FIG. 8A to FIG. 8C show a manufacturing method of a skeleton structural member according to a third embodiment of the invention.

In FIG. 8A, multiple granules 18 and sectionally U-shaped partition wall forming members 35, 35 sandwiching these granules 18 are disposed inside a skeleton member 11. Then, the granules 18 and the partition wall forming members 35, 35 are heated along with the skeleton member 11.

FIG. 8B shows the partition wall forming members 35, 35 shown in FIG. 8A having foamed and expanded under heating to become partition wall members 36, 36, whereby they form a closed space 37 along with the walls of the skeleton member 11. The reference number 38 denotes a completed skeleton structural member. The granules 18 fill the inside of the closed space 37.

FIG. 8C is a variation of the embodiment shown in FIG. 8A. Two sectionally U-shaped partition wall forming members 42, 42 are disposed apart from each other inside a vessel 41, multiple granules 18 are placed between these partition wall forming members 42, 42, and the vessel 41 is inserted into an skeleton member 11. The partition wall forming members 42, 42 inside the vessel 41 are then heated via the skeleton member 11. As a result, the state shown in FIG. 8B mentioned above is reached. At this time, the vessel 41 melts under the heating. If the partition wall forming members 42, 42 and the granules 18 are put inside a vessel 41 like this, it is possible for the vessel 41 to be inserted into the skeleton member 11 easily.

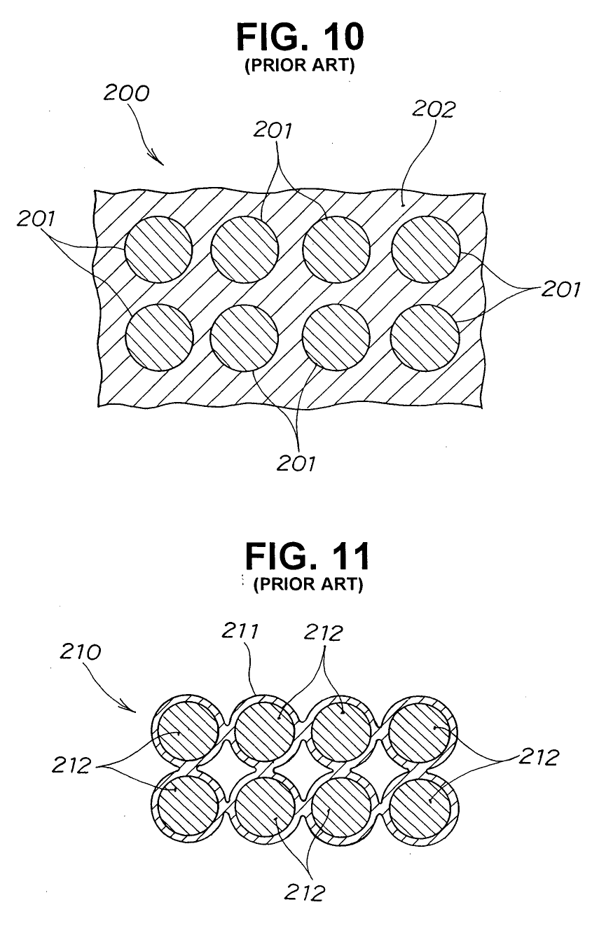

FIG. 9A and FIG. 9B show a manufacturing method of a skeleton structural member according to a fourth embodiment of the invention.

In FIG. 9A, a vessel 47 constituting a partition wall forming member made up of side wall parts 44, 44, a bottom plate 45 and a cover 46 is made with a foaming resin, multiple granules 18 are packed inside this vessel 47, and the vessel 47 is disposed inside a skeleton member 11. The vessel 47 is then heated via the skeleton member 11.

FIG. 9B shows the vessel 47 shown in FIG. 9A having foamed and expanded under the heating to become a closed vessel-shaped partition wall member 48, whereby a closed space 49 is formed inside the partition wall member 48. The reference number 50 denotes the completed skeleton structural member.

As explained with reference to FIG. 4, a skeleton structural member of the present invention has the characteristic feature that, to form a closed space 16 to be filled with multiple granules 18, partition wall members 15, 15 made by expanding partition wall forming members 21, 23 are provided inside a skeleton member 11 and/or a space bounded by a skeleton member and a panel member peripheral to it.

Accordingly, because the partition wall members 15, 15 are formed by expanding partition wall forming members 21, 23, the closed space 16 can be formed easily, and the multiple granules 18 can be packed into the closed space 16 simply, without pressure being applied from outside. Therefore, an internal pressure can be created in the closed space 16, and by means of this internal pressure for example deformation of the vertical wall parts ha (see FIG. 3) of the skeleton structural member 12 can be suppressed, and the rigidity and strength of the skeleton structural member 12 can be increased. As a result, a large load can be supported up to a large displacement, and compared to a skeleton structural member of related art the absorbed energy of the skeleton structural member 12 of the embodiment increases.

If the partition wall forming members 21, 23 are made of a material that expands easily, such as for example a foaming resin material, the weight of the partition wall members 15 can be made low and the skeleton structure member 12 can be made light.

Also, the invention has the characteristic feature that the partition wall forming members 21, 23 are made to expand more rapidly than the granules (for example microcapsules) expand.

If the expansion of the granules completes after the partition wall forming members expand to form the partition walls 15, 15, an internal pressure can be more certainly created in the closed space 16 by the granules.

Also, the invention has the characteristic feature that, as shown in FIG. 8B and FIG. 8C, it is made up of a step of disposing apart from each other inside a vessel 41 (or a bag) multiple partition wall forming members 42, 42 for forming partition wall members 36, 36 inside a skeleton member 11 and/or a space bounded by a skeleton member and a panel member peripheral to it, a step of placing multiple granules 18 between the partition wall forming members 42, 42, a step of disposing the vessel 41 and its contents (or the bag and its contents) inside the skeleton member 11 and/or the space, and a step of heating the vessel 41 its contents (or the bag and its contents).

As a result of the partition wall forming members 42, 42 and the granules 18 being put in the vessel 41 (or bag), the work of disposing the partition wall forming members 42, 42 and the granules 18 inside the skeleton member 11 becomes easy, and the productivity of the skeleton structural member 38 can be raised.

Although in the embodiment of the invention the partition wall forming members were made of a foaming resin material, there is no limitation to this, and alternatively the partition wall forming members may be made of the above-mentioned microcapsules. When the microcapsules are heated, as they expand their surfaces fuse together and the microcapsules bond and form partition walls.

Also, whereas in the embodiment shown in FIG. 2 two partition wall members 15 were provided, there is no limitation to this, and one partition wall member 15 may alternatively be used. In this case, if the granules 18 are sandwiched with one of the end closing members 13 and one partition wall forming member and heated inside the skeleton member 11, it is possible to form one partition wall 15 and form a closed space, and an internal pressure can be created inside the closed space.

Also, as the bag shown in (b) of FIG. 4, a bag made of for example rubber, a resin such as polyurethane, or paper is suitable. And, a vessel may be used instead of a bag.

### INDUSTRIAL APPLICABILITY

As has been explained, because the skeleton structural member described above has high rigidity and strength and increased absorbed energy, it is suitable for use in various types of transport machine.

1. A skeleton structural member for use in a transport machine, comprising:
a hollow skeleton member;
multiple granules packed inside the skeleton member and/or a space bounded by the skeleton member and a panel member peripheral to the skeleton member; and
a partition wall member formed by expanding at least one partition wall forming member provided inside the skeleton member and/or space, for forming a closed space to be packed with the multiple granules.

2. The skeleton structural member according to claim 1, wherein the partition wall forming member expands more quickly than the multiple granules expand.

3. The skeleton structural member according to claim 1, wherein the partition wall forming member is made of a foaming resin material.

4. A method for manufacturing a skeleton structural member to be used in a transport machine, said skeleton structural member having multiple granules packed inside a skeleton member and/or a space bounded by a skeleton member and a panel member peripheral thereto, the manufacturing method comprising the steps of:
disposing a plurality of partition wall forming members for forming partition walls inside the skeleton member and/or space apart from each other inside a vessel or a bag;
placing the granules between the plurality of partition wall forming members;
disposing the vessel and its contents or the bag and its contents inside the skeleton member and/or space; and
heating the vessel and contents of the vessel or the bag and contents of the bag.
